(19) United States
(12) Patent Application Publication
(10) Pub. No.: US 2026/0250175 A1
(43) Pub. Date: Aug. 27, 2026

(54) SYSTEM FOR MANUFACTURING HIGH REFRACTIVE INDEX GLASS BEAD AND METHOD FOR MANUFACTURING HIGH REFRACTIVE INDEX GLASS BEAD USING SAME

(71) Applicant: Jae Koo OH, Seoul (KR)

(72) Inventors: Jae Koo OH, Seoul (KR); Jae Kun LEE, Asan-si (KR)

(21) Appl. No.: 19/540,743

(22) Filed: Feb. 15, 2026

(30) Foreign Application Priority Data
Feb. 25, 2025 (KR) 10-2025-0024193

(51) Int. Cl. C03B 19/10; C03B 5/02; C03B 5/225; C03B 5/23; C03B 33/10

(52) U.S. Cl. CPC C03B 19/1015; C03B 5/021; C03B 5/225; C03B 5/23; C03B 33/107; C03B 2211/70

(57) ABSTRACT

Provided is a system for manufacturing glass beads with a high refractive index, including: a skull melting furnace for melting a glass composition having a high refractive index; a skull refining furnace for stabilizing the glass composition melted through the skull melting furnace, controlling a temperature of the melted glass composition, and forming melted glass composition flows having predetermined viscosity and diameter; a cutting device for cutting the melted glass composition flows to cut bodies; and a cooling tank for cooling the cut bodies, wherein the skull refining furnace is set to a temperature of 1,800 to 2,000°C, the melted glass composition has a viscosity of 1 to 5 cP, and the melted glass composition flows cut by the cutting device have the diameter of 0.4 to 1.2 Ø and a temperature of 1,650 to 1,750°C.

### CROSS REFERENCE TO RELATED APPLICATION OF THE DISCLOSURE

The present application claims the benefit of Korean Patent Application No.10-2025-0024193 filed in the Korean Intellectual Property Office on February 25, 2025, the entire contents of which are incorporated herein by reference.

### BACKGROUND OF THE DISCLOSURE

### Field of the Disclosure

The present disclosure relates to a system for manufacturing glass beads having a high refractive index and a large diameter and a method for manufacturing high refractive index glass beads using the same, more particularly to a system for manufacturing glass beads having a refractive index of about 1.9 or higher and a diameter of about 0.4 to 1.2 Ø, a method for manufacturing the glass beads using the system, and the glass beads manufactured using the method.

As the glass beads according to the present disclosure have a high refractive index and a large diameter, the glass beads are directly applicable to retroreflective paints for road signs or lanes.

### Background of the Related Art

As the market demand for autonomous vehicles has increased, recently, research and development related thereto have been actively conducted.

It is necessary that technologies, such as a high-precision map, a sensor convergence technology, and an artificial intelligence-based detection system, and the like are developed to allow an autonomous vehicle to be driven safely and efficiently. Above all, it is important to accurately recognize an environment around the autonomous vehicle in real time and determine an optimal driving route, and to this end, data processing technology using various sensors such as a Light Detection and Ranging (LiDAR) sensor, a radar sensor, a camera, and the like has been continuously developed.

Further, the lane recognition of the autonomous vehicle is performed by analyzing the contrast between a lane color and a road surface. To allow the autonomous vehicle to stably perform autonomous driving, it is necessary to improve the overall performance of an autonomous driving system and enhance reflection performance thereof so that lanes and road signs can be clearly identified even in a poor environment such as nighttime or bad weather.

To allow road signs and lanes to be accurately recognized by the cameras of the autonomous driving system, the road signs and lanes have to have high retroreflective performance. Retroreflectivity refers to an optical property of reflecting light in an incident direction of the light, and materials having such retroreflectivity are applied to road signs and road surfaces to improve a driver’s visibility and safety. That is, excellent retroreflectivity means that a large amount of incident light is reflected toward an incident direction of the light. Such a property is determined by various factors such as physical properties of a surface, a composition of materials, a refractive index, transparency, and the like, but above all, the most important factor is the refractive index.

Retroreflective materials have been generally developed based on silicon materials with high price competitiveness and excellent optical properties. Further, the retroreflective materials have been developed to have various shapes, such as a bead shape, a prism shape, a planar shape, a combined shape, and the like, but at present, high refractive index glass beads having excellent retroreflective performance are most widely applied to lanes and the like.

One of conventional technologies is disclosed in Korean Patent No. 10-2503346 (Issued on February 24, 2023) that relates to a retroreflective component including: a core; a plurality of glass or glass-ceramic beads adjacent to the core; and a plurality of particles adjacent to the core, wherein each of the particles has a diameter smaller than an average diameter of each glass or glass-ceramic bead, the retroreflective component has an average diameter of 100 to 2000 micrometers, each glass or glass-ceramic bead has an average diameter of 60 to 80 micrometers, and each particle has a diameter of 1 to 60 micrometers.

The conventional retroreflective component disclosed in Korean Patent No. 10-2503346 serves to prevent retroreflectivity from deteriorating even when a liquid road surface sign component of a road sign composition wicks or covers all or a significant portion of the retroreflective component. However, the glass or glass-ceramic beads, which play the most important role in retroreflectivity, simply exist in a state of being attached to the core, so that they are easily separated from the core due to abrasion generated while a vehicle is driven, thereby making retroreflective performance rapidly deteriorated, and disadvantageously, a method for manufacturing the conventional retroreflective component is also complicated. In addition, since the conventional retroreflective component includes the core and the glass or glass-ceramic beads coated thereon, interfaces on which incident light is refracted increase in number, thereby inevitably increasing a light loss due to diffusion, reflection, etc.

Another conventional technology is disclosed in Korean Patent No. 10-0773438 (Issued on November 5, 2007) that relates to a method for manufacturing retroreflective glass beads that includes a first step of forming a resin layer on top of a polyester polymer film 10, a second step of uniformly applying glass beads 20 by a mechanical method through a press roller 32 and a support roller 34 positioned above and below the transparent polymer film 10 in such a way as to allow only half of the diameter of each glass bead 20 to be seated into the coated resin layer, a third step of depositing aluminum vacuum deposition films 40 onto the glass beads 20 whose tops are exposed to the outside in a state where their half is seated into the resin layer to increase a retroreflected luminance rate, and a fourth step of separating the glass beads whose half is deposited with the aluminum vacuum deposition films 40 from the polymer film 10 through a glass bead separation (detachment) roller 60 positioned above the polymer film 10.

However, the conventional method disclosed in Korean Patent No. 10-0773438 is applied to the production of microspheres having a diameter of 55 to 65 µm, so that the method is not suitable for the production of large glass beads having a diameter of 0.4 Ø or above. Further, the conventional method has a limitation in that there is no consideration of the refractive indexes of the glass beads themselves.

Therefore, there is a need to develop glass beads having a high refractive index, excellent retroreflectivity, and a large diameter so that the glass beads are not easily lost due to wear, maintain their high refractive index even when worn, and minimize light losses.

However, a glass composition with a high refractive index has a very high melting point and a high specific gravity, and therefore, glass beads having a large diameter may not be manufactured through a conventional floating type glass bead manufacturing method using a gas burner.

Therefore, until now, there is no method for manufacturing glass beads having a high refractive index and a large diameter.

### SUMMARY OF THE DISCLOSURE

Accordingly, the present disclosure has been made in view of the above-mentioned problems occurring in the related art, and it is an object of the present disclosure to provide a system for manufacturing glass beads having a high refractive index of about 1.9 or higher and a diameter of about 0.4 to 1.2 Ø, and a method for manufacturing glass beads using the system.

To accomplish the above-mentioned object, according to one aspect of the present disclosure, there is provided a system for manufacturing glass beads with a high refractive index, including: a skull melting furnace for melting a glass composition having a high refractive index; a skull refining furnace for stabilizing the glass composition melted through the skull melting furnace, controlling a temperature of the melted glass composition, and forming melted glass composition flows having predetermined viscosity and diameter; a cutting device for cutting the melted glass composition flows to cut bodies; and a cooling tank for cooling the cut bodies, wherein the skull refining furnace may be set to a temperature of 1,800 to 2,000°C, the melted glass composition may have a viscosity of 1 to 5 cP, and the melted glass composition flows cut by the cutting device may have the diameter of 0.4 to 1.2 Ø and a temperature of 1,650 to 1,750°C.

According to the present disclosure, preferably, the skull refining furnace may include: a skull refining furnace body; a high frequency induction coil; and a nozzle, and the nozzle may have orifices having a diameter of 0.8 to 2.4 Ø and be made of a platinum-rhodium alloy.

According to the present disclosure, preferably, the cutting device may include: a rotatable cutting blade; and a cutting blade cooling tank for cooling the cutting blade, and the cutting blade may be a drum-type cutting blade made of a graphite material.

According to the present disclosure, preferably, the cooling tank may have cooling water set to a temperature of 10 to 30°C, and the cut bodies introduced into the cooling tank may be set to a temperature of 1,200°C or higher.

To accomplish the above-mentioned object, according to another aspect of the present disclosure, there is provided a method for manufacturing glass beads with a high refractive index using the system according to one aspect of the present disclosure, the method including the steps of: melting a glass composition having a high refractive index in a skull melting furnace; stabilizing the melted glass composition in a skull refining furnace, controlling a temperature of the melted glass composition, and discharging the melted glass composition from the skull refining furnace in such a way as to form melted glass composition flows having predetermined viscosity and diameter; cutting the melted glass composition flows to cut bodies through a cutting device; and cooling the cut bodies through a cooling tank.

### BRIEF DESCRIPTION OF THE DRAWINGS

The above and other objects, features and advantages of the present disclosure will be apparent from the following detailed description of the preferred embodiments of the disclosure in conjunction with the accompanying drawings, in which:

FIG. 1 illustrates a system for manufacturing glass beads with a high refractive index according to the present disclosure;

FIG. 2 illustrates a skull refining furnace in the system for manufacturing the glass beads with a high refractive index according to the present disclosure;

FIGS. 3A to 3C illustrate examples in which melted glass composition flows are cut, wherein FIGS. 3A and 3C show the examples in which devitrification occurs and FIG. 3B shows the example in which cutting is not properly performed; and

FIG. 4 illustrates glass beads manufactured using the system for manufacturing the glass beads with a high refractive index according to the present disclosure.

### DETAILED DESCRIPTION OF THE PREFERRED EMBODIMENTS

The terminology used herein is for the purpose of describing particular embodiments only and is not intended to be limiting of the disclosure. In the present specification, the singular forms include the plural forms unless otherwise specified in the phrase. It will be further understood that the terms “comprises” and/or “comprising,” when used in this specification, specify the presence of stated components, but do not preclude the presence or addition of one or more other components.

Unless otherwise defined, all terms (including technical and scientific terms) used herein have the same meaning as commonly understood by one of ordinary skill in the art to which the present disclosure pertains. In addition, terms defined in commonly used dictionaries are not ideally or excessively interpreted unless expressly specifically defined.

Hereinafter, embodiments of the present disclosure will be explained in detail with reference to the accompanying drawings so that those skilled in the art to which the present disclosure pertains can easily implement the present disclosure. The present disclosure may, however, be embodied in many different forms and should not be construed as limited to the embodiments set forth herein.

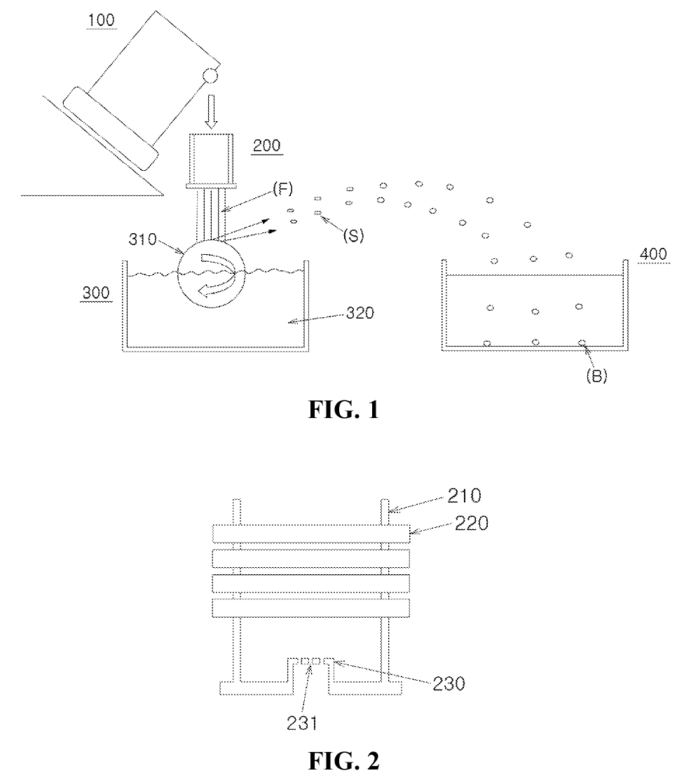

FIG. 1 illustrates a system for manufacturing glass beads with a high refractive index according to the present disclosure.

According to the present disclosure, a system for manufacturing glass beads with a high refractive index comprises a skull melting furnace (SMF) 100, a skull refining furnace (SRF) 200, a cutting device 300, and a cooling tank 400.

The skull melting furnace 100 may be used without limitation only if it serves to completely melt a glass composition having a high refractive index in a short time and thus reduce the viscosity of the melted glass composition, but as the skull melting furnace 100, a high-frequency skull melting furnace is preferably used for melting the glass composition having a high melting point.

Conventional various high-frequency skull melting furnaces may be used as the high-frequency skull melting furnace, and therefore, a detailed description thereof will be omitted. According to an embodiment, a high-frequency skull crucible as disclosed in Korean Patent No. 10-2577700 may be used.

The skull melting furnace 100 is maintained at a temperature of about 1,900 to 2,500°C, and the high refractive index glass composition melted in the skull melting furnace 100 is discharged from the skull melting furnace 100 and supplied to the skull refining furnace 200.

In the skull melting furnace 100, components having different specific gravities are mixed and melted, and the melting temperature is also very high, so that it is impossible to uniformly stir the melted material. Therefore, the composition ratio of the melted material may not be uniform depending on the position in the skull melting furnace 100, and the temperature thereof is also very high, so that it is very difficult to directly manufacture glass beads with the melted material discharged from the skull melting furnace 100.

The skull refining furnace 200 is designed to remove such a problem and thus serves to remove bubbles in the melted material supplied from the skull melting furnace 100 and perform stabilization and uniformization of the melted material. Further, the skull refining furnace 200 serves to discharge the melted material in a constant diameter, while maintaining the melted material at constant viscosity and temperature, and the skull refining furnace 200 may be freely used only if it serves so, without any limitation. As the skull refining furnace 200, however, a high-frequency skull refining furnace having a high-frequency induction coil 220 is preferably used to refine the glass composition having a high melting point.

The skull refining furnace 200 includes a skull refining furnace body 210, the high-frequency induction coil 220 located on the outer surfaces of the skull refining furnace body 210, and a nozzle 230.

In this case, the nozzle 230 is formed of a platinum alloy that is not melted at the melting point of the high refractive index glass composition, particularly formed of an alloy composed of 80% platinum and 20% rhodium, and the nozzle 230 has orifices 231 having a diameter of about 0.8 to 2.4 Ø so that the melted glass composition discharged through the orifices 231 forms melted flows F with a diameter of about 0.4 to 1.2 Ø.

More preferably, each orifice 231 has a diameter of about 1.6 to 2.0 Ø, and each melted flow F has a diameter of 0.8 to 1.0 Ø.

The nozzle 230 is located at a position higher than the bottom of the skull refining furnace body 210 to prevent the orifices 231 from clogging due to cooling of the bottom.

The skull refining furnace 200 is kept at a temperature of about 1,800 to 2,000°C, preferably about 1,900°C, and the high refractive index glass composition melted in the skull refining furnace 200 is kept at a viscosity of about 1 to 5 cP and discharged through the orifices 231 of the nozzle 230 to form the melted flows F.

If the viscosity of the melted glass composition is less than the above range, it is difficult to form large diameter melted flows F, and if the viscosity of the melted glass composition exceeds the above range, it is difficult to discharge the melted glass composition to the orifices 231.

The melted flows F formed through the skull refining furnace 200 are supplied to the cutting device 300.

The cutting device 300 includes a rotatable cutting blade 310 and a cutting blade cooling tank 320 for cooling a portion of the cutting blade 310.

The cutting blade 310 serves to cut the melted glass composition flows F having predetermined diameter and strength at regular intervals, and any cutting blade may be used without limitation only if it serves so. In this case, a drum-type cutting blade capable of continuously cutting the melted flows F is preferably used, and it is more preferably to use a graphite-based cutting blade that has a low coefficient of friction so that it does not adhere the melted material thereto even when in contact with the high-temperature melted material and is excellent in abrasion resistance, heat resistance, and thermal conductivity, thereby having no thermal damage and being easily cold.

The cutting blade cooling tank 320 serves to cool the cutting blade 310 whose temperature rises during the process of cutting the melted glass composition flows F so that the cutting blade 310 can maintain a constant temperature and serves to constantly supply water to the surface of the cutting blade 310 so that the melted material is prevented from adhering to the surface of the cutting blade 310.

The cutting blade 310 continuously cuts the melted glass composition flows F to a length similar to the diameter of each melted glass composition flow F, and cut bodies S, which are cut by the cutting blade 310, are molded to a spherical shape by interfacial tension with air, while flying in the air, and then introduced into the cooling tank 400.

In the process of cutting the melted glass composition flows F, the temperatures of the melted flows F should be very precisely controlled, and in this case, the temperatures of the melted flows F are set to about 1,650 to 1,750°C, preferably about 1,700°C.

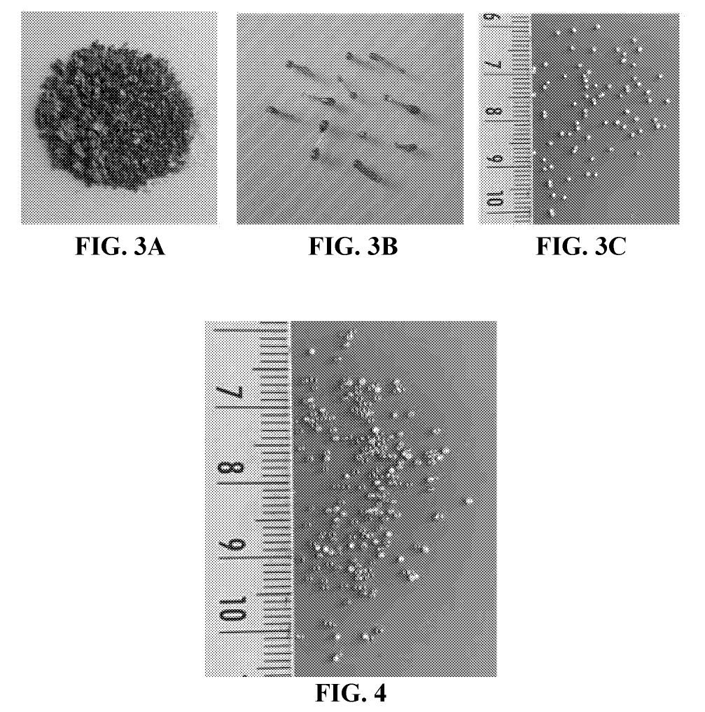

If the temperatures of the melted flows F are less than the above range, devitrification occurs, thereby failing to expect excellent visible light transmittance (See FIG. 3A), and if the temperatures of the melted flows F exceed the above range, cutting is not completely performed, thereby forming tailed cut bodies (See FIG. 3B) or having oval shapes, while flying in the air.

As described above, the cut bodies S that are cut by the cutting blade 310 have the spherical shapes, while flying in the air, are then introduced into the cooling water of the cooling tank 400, and finally cooled in the cooling tank 400, thereby being manufactured as glass beads B having a diameter of about 0.4 to 1.2 Ø, preferably about 0.8 to 1.0 Ø.

The temperatures of the cut bodies S before being introduced into the cooling water are maintained at a temperature of about 1,200°C or higher, preferably set to about 1,300°C.

If the temperatures of the cut bodies S are less than the above temperature, devitrification occurs, thereby failing to expect excellent visible light transmittance (See FIG. 3C).

In addition, the temperature of the water filled in the cooling tank 400 is set to 10 to 30°C, preferably 20°C.

If the water temperature of the cooling tank 400 is less than the above temperature, cracks may occur on the glass beads due to rapid cooling, and if the water temperature exceeds the above temperature, devitrification may occur. In this case, the possibility of such devitrification increases as the sizes of the glass beads B increase. That is, it is preferable that the cut bodies S be cooled in the cooling tank 400 as fast as possible so that differences between the inside cooling rates and the outside cooling rates of the glass beads B are not great.

Hereinafter, a method of manufacturing high refractive index glass beads using the system according to the present disclosure will be described in detail.

A glass composition comprising 37 wt% of TiO₂, 32 wt% of BaO, 11 wt% of SiO₂, 6 wt% of ZrO₂, and 14 wt% of La₂O₃ was prepared and then completely melted in a high-frequency induction heating type skull melting furnace.

The melted glass composition was transferred to a skull refining furnace and then maintained therein for about 30 minutes until the melted glass composition had a temperature of about 1,900°C.

Orifices each having a diameter of about 1.6 Ø, which are formed on a nozzle of the skull refining furnace, were opened to form melted flows having a diameter of about 0.8 Ø, which were cut using a drum-type graphite cutting blade having a diameter of 350 Ø. In this case, the cutting blade was rotated at about 1,800 rpm.

In the process of cutting the melted flows of the glass composition using the cutting blade, the temperatures of the melted flows were maintained at about 1,700°C, and the cut bodies by the cutting blade flew into the air and were then cooled in a cooling tank filled with cooling water maintained at about 20°C, thereby being manufactured as glass beads having a diameter of about 0.8 Ø (See FIG. 4).

The glass beads have a refractive index of 1.95, which is higher than that of general glass beads, while having a large diameter of about 0.8 Ø, so that the glass beads themselves can be used in a road sign composition or the like, without a separate process such as coating a material having an additional high refractive index, and there is an advantage in that their loss generated due to vehicle driving is not large and the high refractive index is maintained even when they are worn.

As described above, the glass beads according to the present disclosure have excellent retroreflectivity because they have a high refractive index of about 1.9 or higher and are not easily worn out by external friction because they have a large diameter of about 0.4 to 1.2 Ø, so that even if they are worn out, their retroreflectivity is not significantly deteriorated, thereby being still maintained for a long time when they are used in a road sign composition.

In addition, the system for manufacturing high refractive index glass beads and the method for manufacturing the high refractive index glass beads using the same according to the present disclosure can provide the glass composition having a high melting point and a high specific gravity as the melted material having constant temperature and viscosity and uniformly cut and cool the melted material to prevent devitrification from occurring, thereby manufacturing a large amount of glass beads having excellent visible light transmittance.

While the present disclosure has been made with reference to the particular illustrative embodiment, it is not to be restricted by the embodiment but only by the appended claims. It is to be appreciated that those skilled in the art can change or modify the embodiment without departing from the scope and spirit of the present disclosure.

What is claimed is:

1. A system for manufacturing glass beads with a high refractive index, the system comprising:
a skull melting furnace for melting a glass composition having a high refractive index;
a skull refining furnace for stabilizing the glass composition melted through the skull melting furnace, controlling a temperature of the melted glass composition, and forming melted glass composition flows having predetermined viscosity and diameter;
a cutting device for cutting the melted glass composition flows to cut bodies; and
a cooling tank for cooling the cut bodies,
wherein the skull refining furnace is set to a temperature of 1,800 to 2,000°C, the melted glass composition has a viscosity of 1 to 5 cP, and the melted glass composition flows cut by the cutting device have the diameter of 0.4 to 1.2 Ø and a temperature of 1,650 to 1,750°C.

2. The system according to claim 1, wherein the skull refining furnace comprises:
a skull refining furnace body;
a high frequency induction coil; and
a nozzle.

3. The system according to claim 2, wherein the nozzle comprises orifices having a diameter of 0.8 to 2.4 Ø, and the nozzle is made of a platinum-rhodium alloy.

4. The system according to claim 1, wherein the cutting device comprises:
a rotatable cutting blade; and
a cutting blade cooling tank for cooling the cutting blade.

5. The system according to claim 4, wherein the cutting blade is a drum-type cutting blade made of a graphite material.

6. The system according to claim 1, wherein the cooling tank has cooling water set to a temperature of 10 to 30°C.

7. The system according to claim 6, wherein the cut bodies introduced into the cooling tank are set to a temperature of 1,200°C or higher.

8. A method for manufacturing high refractive index glass beads using the system according to any one of claim 1, the method comprising:
melting a glass composition having a high refractive index in a skull melting furnace;
stabilizing the melted glass composition in a skull refining furnace, controlling a temperature of the melted glass composition, and discharging the melted glass composition from the skull refining furnace in such a way as to form melted glass composition flows having predetermined viscosity and diameter;
cutting the melted glass composition flows to cut bodies through a cutting device; and
cooling the cut bodies through a cooling tank.
